(19) United States
(12) Patent Application Publication
(10) Pub. No.: US 2006/0288498 A1
(43) Pub. Date: Dec. 28, 2006

(54) Yellow dye composition

(75) Inventors: Ming-Mei Yeh, Yangmei Township (TW); Shiun-Jenn Chen, Jhongli City (TW); Li-Ping Sun, Taipei City (TW)

Correspondence Address: BACON & THOMAS, PLLC, 625 SLATERS LANE, FOURTH FLOOR, ALEXANDRIA, VA, 22314, US

(73) Assignee: Everlight USA, Inc., Pineville, NC (US)

(21) Appl. No.: 11/281,478

(22) Filed: Nov. 18, 2005

(30) Foreign Application Priority Data
Jun. 23, 2005 (CN) 200510079586.6

(51) Int. Cl. C09B 62/00

(52) U.S. Cl. 8/543

(57) ABSTRACT

A dye composition, which comprising two or three components, each component is different with another and is selected from the formula (I), (II), or (III). 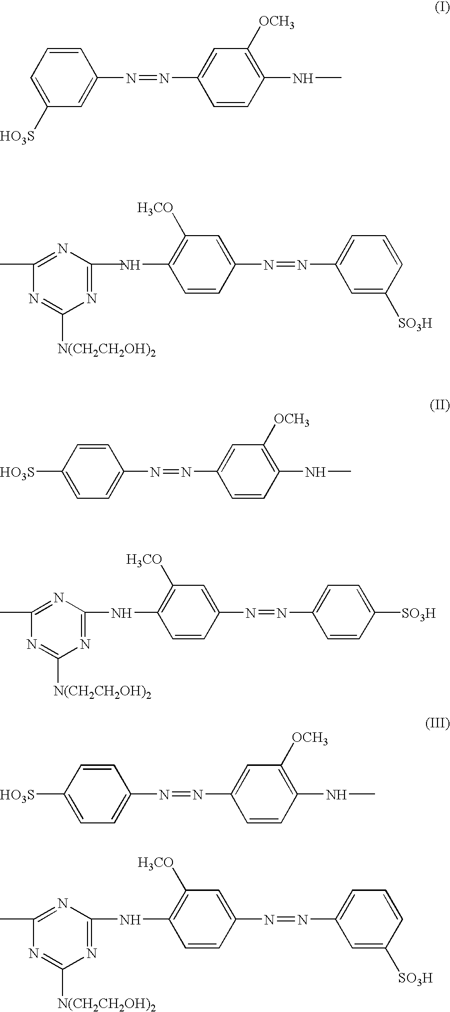 The yellow dye composition disclosed here is a dye composition with good stability of aqueous dye solution, good storage stability, high solubility and excellence light fastness. The yellow dye composition is suitable for the cellulose fibers in dyeing and printing.

### BACKGROUND OF THE INVENTION

1. Field of the Invention

The present invention relates to a dye composition, more particularly to a novel yellow dye composition suited for the dyeing and printing of cellulose fibers, predominantly in the paper and pulp applications.

2. Description of Related Art

The direct yellow dyestuff are used widely and recognized in the paper industries for years, yet the primarily qualities such as hue, concentration, solubility, fastness and economic dyeing properties can not be fully satisfied. A yellow dyestuff with good properties is still expected by the market. For example, in Japanese Patent Laid-open No. 55-36208 a paper use yellow dye having outstanding hue, very fine light fastness as well resist to discoloration etc is disclosed, thus it is widely used in the paper industries, yet shortcomings such as poor build up and poor solubility are exposed and in need of improvement.

Even so the need for others still exist, in particular neutral or light greenish direct yellow dyestuffs. Where these dyestuffs demonstrate high tinctorial strength and excellent exhaustion properties, while having sufficient water solubility providing stability for the water soluble additives so that large amounts of dissolution agent are not needed. Other than that, the obtained dyestuffs demonstrate high light fastness with bleaching ease.

The present inventors have widely researched on paper use dyes that satisfy the needs from which the foregoing disadvantages are absent. It is then found that the aforementioned problem can be solved with the use of the dye composition of the present invention. Dye composition of the kind has higher affinity to the fibers, as well consists of qualities such as good dye liquor stability, good storing stability, good solubility, good build up and high light fastness. As for other fastness testing, excellent results are exhibited at the same time having very good leveling and meets the environmental needs.

### SUMMARY OF THE INVENTION

The present invention provides a paper use direct yellow dye composition having good properties in storing stability, solubility and light fastness. The present invention also provides a paper use direct yellow dye composition having good properties in fastness and cost down advantage.

The dye composition of the present invention may comprises two or three components.

As to the dye composition of the present invention is a two-components composition, the dye composition of the present invention is comprised a component (a) and a component (b), said component (a) and component (b) are different with each other and are selected from the diazo dye of the following formula (I), (II), or (III).

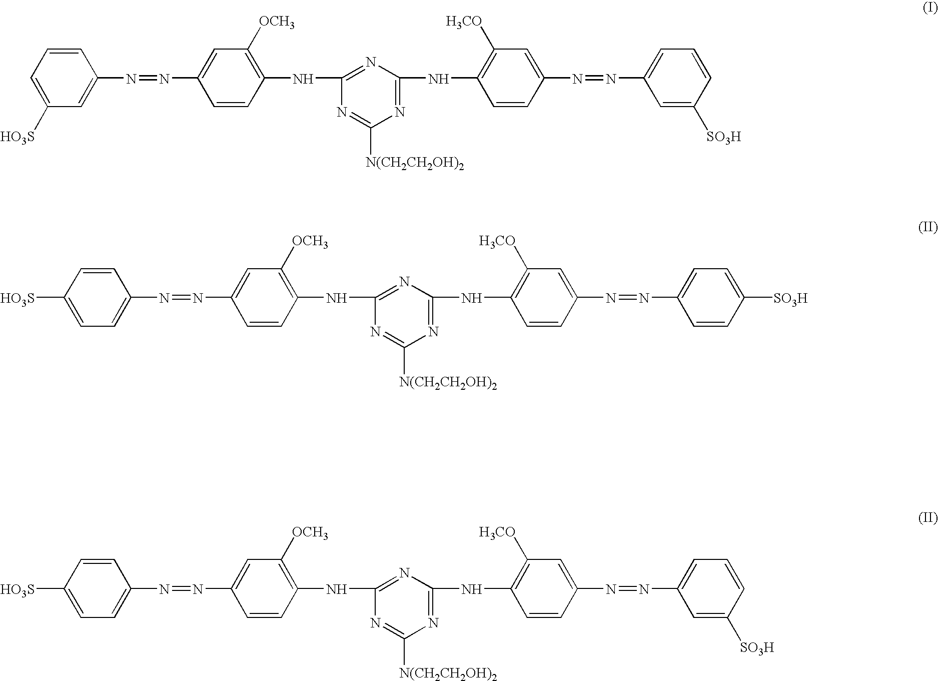

As to the dye composition of the present invention comprising of two components, the component ratio is not critical. Preferably the component ratio of said component (a) is 99% to 1% by weight, and the component ratio of said component (b) is 1% to 99% by weight. More preferably the component ratio of said component (a) is 90% to 10% by weight, and the component ratio of component (b) is 10% to 90% by weight.

In the selection of the two components of the dye composition of the present invention an example can be, wherein said component (a) is diazo dye of formula (I), and component (b) is diazo dye of formula (II). Further exemplification can be, wherein said component (a) is diazo dye of formula (I), and component (b) is diazo dye of formula (III). Another exemplification can be, wherein said component (a) is diazo dye of formula (II), and component (b) is diazo dye of formula (III).

As to the dye composition of the present invention is a three-components composition, the dye composition of the present invention is comprised a component (a), a component (b), and a component (c), said component (a), component (b), and component (c) are different with one another and are selected from the diazo dye of the aforementioned formula (I), (II) or (III). As to the dye composition of the present invention comprising of three components, the component ratio is not critical. Preferably the component ratio of said component (a) is 98% to 1% by weight, the component ratio of said component (b) is 98% to 1% by weight, and the component ratio of said component (c) is 98% to 1% by weight. More preferably the component ratio of said component (a) is 89% to 30% by weight, the component ratio of said component (b) is 10% to 30% by weight, and the component ratio of said component (c) is 1% to 40% by weight.

In the selection of the three components of the dye composition of the present invention an example can be, wherein said component (a) is diazo dye of formula (I), component (b) is the diazo dye of formula (II), and component (c) is the diazo dye of formula (III).

The dye composition of the present invention is suitable for the dyeing and printing of natural or synthetic cellulose fibers (particularly paper derivatives), and can obtain dye material with various fine dye properties, especially to the dye liquor, it is outstanding in stability, storage stability, solubility and light fastness.

For the convenience in the statement of the present invention, the compounds are expressed as free acid in the specification. When the dyestuffs of the present invention are manufactured or used, they often exist in the form of water soluble salts, suitable salts include alkaline metallic salts, alkaline earth metals, ammonium salts or organic amine salts, wherein preferably it is sodium salts, potassium salts, lithium salts, ammonium salts or triethanolamine salts.

### DETAILED DESCRIPTION OF THE PREFERRED EMOBODIMENT

The synthesis of the compound of formula (I) of the present invention may be referred to the U.S. Pat. No. 3,945,990.

The synthesis of the compound of formula (II) of the present invention may be referred to the Japanese Patent Laid-open No. 55-36208.

The compound of formula (III) may be synthesized as follows. First, obtain the amino compound of formula (a), along with the following halotriazine of formula (b) under acidic to weak acidic pH (pH=1-5) and a 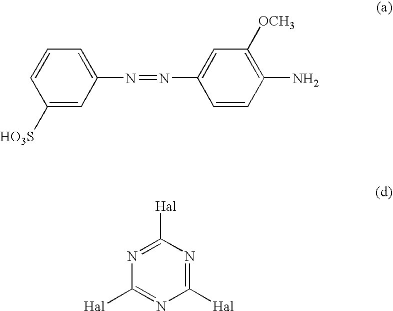
temperature of 0-20° C. a first condensation reaction is carried out, wherein Hal is halogen such as fluorine, chlorine or bromine atom. Next with the amino compound of the following formula (c) between weak acidic to 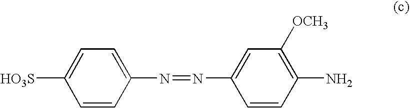
basic pH such as a pH between 4.0-8.0 and a temperature of 20-65° C. a second condensation reaction is carried out. Lastly with the diethanolamine of formula (d) under a neutral to weak basic pH (pH=7-10) and a 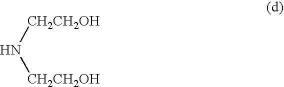
temperature of 70-100° C. a third condensation reaction is carried out, and the compound of formula (III) of the present invention is obtained.

The composition of the present invention can be prepared in many ways. For example, by using separately prepared dye components mixing each dye together, or it can be prepared by mixing one component alone then with another component. The way of mixing is by using proper mixer, for example, as in a ball and sand grinder. In the same way, individual dye with different components can make dyeing liquid through stirring, or through control of conditions in each dye preparation to produce an ideal mixture. In the process of exhausting or printing, separate dyes can mixed together or mixed with other dyes.

If necessary, the dye compositions of the present invention may be contained with inorganic salts (e.g. sodium sulfate or sodium chloride), dispersants (e.g. β-naphthalene sulfonic acid-formaldehyde condensation products, methyl naphthalene sulfonic acid-formaldehyde condensation products, acetyl amino naphthol based compounds, etc.), non-dusting agents (e.g. di-2-ethylhexyl terephthalate, etc.), pH buffer agents (e.g. sodium acetate, sodium phosphate, etc.), water softeners (e.g. polyphosphate, etc.), well-known dyeing assistants, and etc.

The form of the dye compositions of the present invention is not critical. The dye compositions of the present invention can be in the form of powders, granules or liquids.

The dye compositions of the present invention can dye many kinds of fiber materials such as cellulose fiber materials and cellulose included fiber materials. The cellulose fiber materials are not critical. These dye compositions can also be used to dye natural cellulose fibers and regenerated cellulose fibers (particularly paper derivatives), such as cotton, linen, jute, ramie, mucilage rayon, as well as cellulose based fibers.

The dyeing or printing of the mentioned materials are by the general practiced dyeing procedures used in the industries, so that bright yellow dye material or print material having good light fastness, wash fastness, build up and chlorine bleaching fastness can be obtained.

Many examples have been used to illustrate the present invention. The examples sited below should not be taken as a limit to the scope of the current invention. In these examples, the compound is represented by the free acid. However, in practice, it will exist as alkali salt, for example as the sodium, lithium, potassium or ammonium salt, particularly the sodium salt. In the following examples, quantities are given as parts by weight (%) and temperature are given in degree Celsius.

### PREPARATION EXAMPLE 1

Under room temperature 33.5 parts of 4-Amino-3-methoxyazobenzene-3′-sulfonic acid are well stirred and dissolved in 175 parts of water, then the solution is cooled to 0-5° C. by adding of ice and 20.25 parts of Cyanuric chloride are added into the solution to proceed the first condensation reaction. The pH of the reaction solution is gradually adjusted to 4-4.5 by using the powdered sodium bicarbonate, then the reaction solution is stirred until the reaction has completed. Next 33.5 parts of 4-Amino-3-methoxyazobenzene-4′-sulfonic acid are added to the reaction solution to proceed a second condensation reaction, the temperature is elevated to 40-65° C., and then with the use of powdered sodium bicarbonate the pH of the reaction solution is gradually adjusted to 5-7 and is stirred until the reaction is completed. Lastly 17.0 parts of Diethanolamine are added, with soda ash the pH is maintained between 8˜9.5 with the temperature being maintained at 80˜100° C. , the mixture is stirred until the third condensation reaction has completed and a compound of the following formula (III) is obtained:

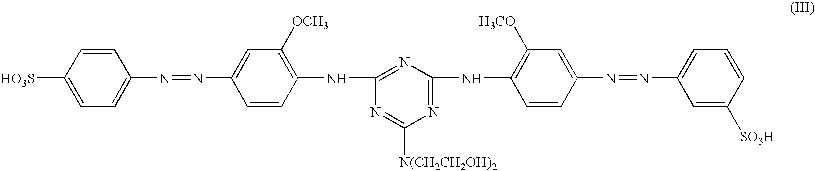

### EXAMPLE 1

85 parts of formula (I) and 15 parts of formula (II) are mixed homogeneous to form a dye composition.

### EXAMPLE 2

75 parts of formula (I) and 25 parts of formula (III) are mixed homogeneous to form a dye composition.

### EXAMPLE 3

85 parts of formula (II) and 15 parts of formula (III) are mixed homogeneous to form a dye composition.

### EXAMPLE 4

15 parts of formula (I) and 85 parts of formula (II) are mixed homogeneous to form a dye composition.

### EXAMPLE 5

25 parts of formula (I) and 75 parts of formula (III) are mixed homogeneous to form a dye composition.

### EXAMPLE 6

15 parts of formula (II) and 85 parts of formula (III) are mixed homogeneous to form a dye composition.

### EXAMPLE 7

39 parts of formula (I), 28 parts of formula (II) and 33 parts of formula (III) are mixed homogeneous to form a dye composition.

### EXAMPLE 8

Under room temperature 33.5 parts of 4-Amino-3-methoxyazobenzene-3′-sulfonic acid and 33.5 parts of 4-Amino-3-methoxyazobenzene-4′-sulfonic acid are well stirred and dissolved in 350 parts of water, where then the pH is adjust to a neutral pH and with the addition of ice the temperature is cooled to 0˜5° C. Follow up 20.25 parts of Cyanuric chloride are added to the afore solution for carrying out the first and second condensation reaction, the temperature is then elevated to 40˜65° C., with the use of the powdered sodium bicarbonate the reaction pH is gradually adjusted to 5˜7 and is stirred till the reaction is completed. After 17.0 parts of diethanolamine are added, and with soda ash the pH is maintained between 8˜9.5 with the temperature being maintained at 80˜100° C., the mixture is stirred until the third condensation reaction has completely. Lastly it is salted out with the addition of sodium chloride and then the solution is filtered to obtain a dye composition.

### COMPARATIVE EXAMPLE 1

100% dyestuff of formula (I) is used as a comparative dye.

In order to prove the good dyeing properties of the dye composition of the present invention, the following solubility tests are carried out.

### TEST EXAMPLE 1, SOLUBILITY TEST

The dye composition of comparative example 1 and examples 1-8 are tested to evaluate single color solubility, the procedure and result of the tests are as follow.

Procedure of the Test:

First, two dye powders of 10 g and 20 g are prepared, and are added to separate 100 g distilled water under room temperature and stirred for 10 minutes. Follow up the dye liquors are filtered by pouring into a filter covered with Toyo Roshi Kaisha, Ltd. Number 1 filter paper on top, after the filter paper is examined for granules like residues to determine the solubility.

Result of the Test:

The result of the solubility testing is summarized in table 1 below.

TABLE 1

| | 10 g dye | 20 g dye |
|---|---|---|
| example 1 | ⊚ | ⊚ |
| example 2 | ⊚ | ⊚ |
| example 3 | ⊚ | ⊚ |
| example 4 | ⊚ | ⊚ |
| example 5 | ⊚ | ⊚ |
| example 6 | ⊚ | ⊚ |
| example 7 | ⊚ | ⊚ |
| example 8 | ⊚ | ⊚ |
| comparative example 1 | Δ | X |

⊚: no granule like residues
Δ: insignificant amount of granule like residues
X: significant amount of granule like residues

During the single color testing, it is apparent that the dyeing properties of the composition of examples 1-8 are better than the comparative example 1.

From the above Table 1, we can conclude that the solubility properties of the composition of examples 1-8 are better than that of the composition of comparative example 1.

The dye composition of the present invention is a general dye composition that is suited for cellulose fibers dyeing and printing, predominantly for paper derivatives. The dying or printing on the mentioned dye materials are by the general practiced dyeing procedures used in the industries, in addition the results showing excellent unique properties.

The dye compositions described in the present invention are water-soluble dyestuffs having high commercial values, as well having fine properties in dye liquor stability, storing stability, solubility etc. The dye compositions of the present invention can obtain dyeing results with excellent properties in all aspects, especially demonstrating very fine results in leveling, build-up and light fastness.

From the foregoing description, one skilled in the art can easily ascertain the essential characteristics of this invention and without departing from the scope thereof, one can make various changes and modifications of the invention to adapt it to various usages and conditions. Thus other embodiments are also within the claim.

1. A dye composition comprising a component (a) and a component (b), the component (a) and component (b) are different with each other and are selected from the diazo dye of the following formula (I), (II) and (III), 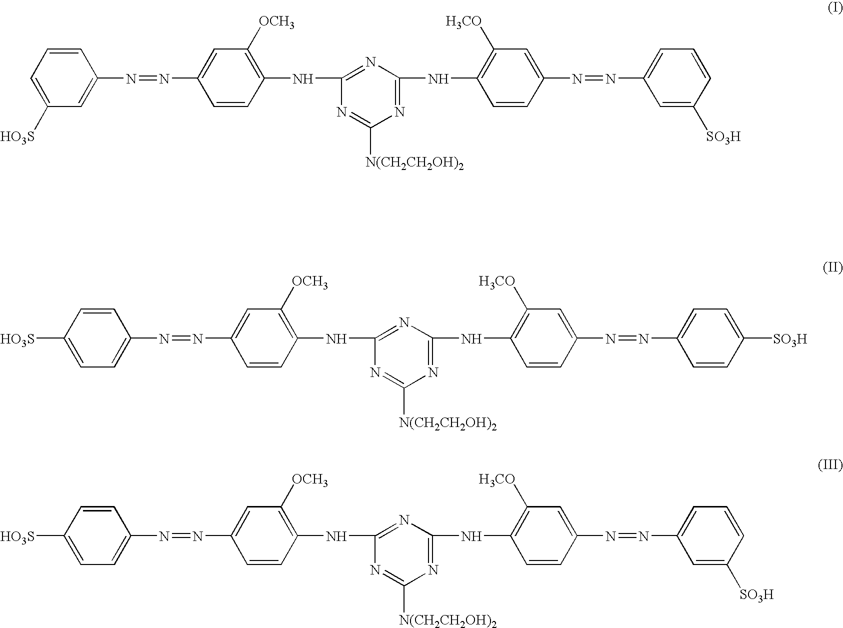
wherein, the component ratio of component (a) is 90% to 10% by weight, and the component ratio of component (b) is 10% to 90% by weight.

2. (canceled)

3. The dye composition of claim 1, wherein said component (a) is diazo dye of formula (I), and said component (b) is diazo dye of formula (II).

4. The dye composition of claim 1, wherein said component (a) is diazo dye of formula (I), and said component (b) is diazo dye of formula (III).

5. The dye composition of claim 1, wherein said component (a) is diazo dye of formula (II), and said component (b) is diazo dye of formula (III).

6. A dye composition comprising a component (a), a component (b), and a component (c), the component (a), component (b), and component (c) are different with one another and are selected from the diazo dye of the following formula (I), (II), and (III) of the claim 1, wherein, the component ratio of component (a) is 89% to 30% by weight, the component ratio of component (b) is 10% to 30% by weight, and the component ratio of component (c) is 1% to 40% by weight.

7. (canceled)

8. The dye composition of claim 5, wherein said component (a) is diazo dye of formula (I), the component (b) is diazo dye of formula (II), and the component (c) is diazo dye of formula (III).
